(19) United States
(12) Patent Application Publication
(10) Pub. No.: US 2016/0138350 A1
(43) Pub. Date: May 19, 2016

(54) CONTROL OF MANAGED PRESSURE DRILLING

(71) Applicant: SCHLUMBERGER TECHNOLOGY CORPORATION, Sugar Land, TX (US)

(72) Inventors: Kjetil Havre, Skedsmokorset (NO); Ashley Bernard Johnson, Cambridge (GB); Maurice Ringer, Roissy-en-France (FR); Walter David Aldred, Cambridge (GB)

(21) Appl. No.: 14/649,782

(22) PCT Filed: Dec. 5, 2013
(86) PCT No.: PCT/IB2013/060672

§ 371 Date: Jun. 4, 2015

Related U.S. Application Data
(60) Provisional application No. 61/733,828, filed on Dec. 5, 2012.

(51) Int. Cl. E21B 21/08; E21B 21/16; G05B 11/42; E21B 21/06

(52) U.S. Cl. CPC E21B 21/08; E21B 21/062; E21B 21/16; G05B 11/42; E21B 2021/005

(57) ABSTRACT

Method for controlling bottomhole pressure in a borehole during managed pressure drilling. In the drilling procedure fluid is circulated down a drillstring and to surface through an annulus between the drillstring and an inner-wall of the borehole. A compressor/pump is used to inject gas into the returning drilling fluid at a gas injection point. The method comprises receiving a target bottomhole pressure; determining actual bottomhole pressure during the procedure; and adjusting a variable as directed by a feedback controller, which operates to reduce the difference between the target pressure and the measured pressure. The manipulated variable may be one or any combination of: (1) pressure of drilling fluid at the entry of the fluid into the drillstring, (2) the flow rate of drilling fluid out of the drillstring into the annulus, (3) pressure of the gas exiting from the compressor, and (4) the injection rate of the gas.

### BACKGROUND

Embodiments of the present disclosure relate to gas injection procedures for use in drilling a subterranean borehole, particularly, but not by way of limitation, for the purpose of extracting hydrocarbons from a subterranean reservoir.

The drilling of a borehole is typically carried out using a steel pipe known as a drillstring with a drill bit coupled on the lower most end of the drillstring. The entire drillstring may be rotated using an over-ground drilling motor, or the drill bit may be rotated independently of the drillstring using a fluid powered motor or motors mounted in the drillstring just above the drill bit. As drilling progresses, a flow of drilling fluid is used to carry the debris created by the drilling process out of the borehole. The drilling fluid is pumped through an inlet line down the drillstring to pass through the drill bit, and returns to the surface via an annular space between the outer diameter of the drillstring and the borehole (generally referred to as the annulus or the drilling annulus).

Drilling fluid is a broad drilling term that may cover various different types of drilling fluids. The term “drilling fluid” may be used to describe any fluid or fluid mixture used during drilling and may cover such things as air, nitrogen, misted fluids in air or nitrogen, foamed fluids with air or nitrogen, aerated or nitrified fluids to heavily weighted mixtures of oil or water with solid particles. Although air or nitrogen are typically used to create a gaseous phase of a drilling fluid, it is also possible to use other less reactive gasses, such as exhaust gases, to create the gaseous phase.

The drilling fluid flow through the drillstring may be used to cool the drill bit. In conventional overbalanced drilling, the density of the drilling fluid is selected so that it produces a pressure at the bottom of the borehole (the “bottom hole pressure” or “BHP”), which is high enough to counter-balance the pressure of fluids in the formation (the “formation pore pressure”). By counter-balancing the pore pressure, the BHP acts to prevent the inflow of fluids from the formations surrounding the borehole. However, if the BHP falls below the formation pore pressure, formation fluids, such as gas, oil and/or water may enter the borehole and produce what is known in drilling as a kick. By contrast, if the BHP is very high, the BHP may be higher than the fracture strength of the formation surrounding the borehole resulting in fracturing of the formation. When the formation is fractured, the drilling fluid—which is circulated down the drillstring and through the borehole, for among other things, removing drilling cuttings from the bottom of the borehole—may enter the formation and be lost from the drilling process. This loss of drilling fluid from the drilling process may cause a reduction in BHP and as a consequence cause a kick as the BHP falls below the formation pore pressure.

In order to overcome the problems of kicks and/or fracturing of formations during drilling, a process known as managed pressure drilling (“MPD”) has been developed. In MPD various techniques may be used to control the BHP during the drilling process. One such method comprises injecting gas into the drilling fluid/mud column in the drilling annulus (during the drilling process drilling fluid/mud is continuously circulated down the drillstring and back up through the annulus formed between the drillstring and the wall of the borehole being drilled and, as a result, during the drilling process a column of drilling fluid/mud is present in the annulus) to reduce the BHP produced by the column of the mud/drilling fluid in the drilling annulus. An MPD system using gas injection is illustrated in FIG. 1.

In MPD, the annulus may be closed using a pressure containment device. This device comprises sealing elements, which engage with the outside surface of the drillstring so that flow of fluid between the sealing elements and the drillstring is substantially prevented. The sealing elements may allow for rotation of the drillstring in the borehole so that the drill bit on the lower end of the drillstring may be rotated. A flow control device may be used to provide a flow path for the escape of drilling fluid from the annulus. After the flow control device, a pressure control manifold, with at least one adjustable choke, valve and/or the like, may be used to control the rate of flow of drilling fluid out of the annulus. When closed during drilling, the pressure containment device creates a backpressure in the borehole, and this back pressure can be controlled by using the adjustable choke or valve on the pressure control manifold to control the degree to which flow of drilling fluid out of the annulus/riser annulus is restricted.

During MPD an operator may monitor and compare the flow rate of drilling fluid into the drillstring with the flow rate of drilling fluid out of the annulus to detect if there has been a kick or if drilling fluid is being lost to the formation. A sudden increase in the volume or volume flow rate out of the annulus relative to the volume or volume flow rate into the drillstring may indicate that there has been a kick. By contrast, a sudden drop in the flow rate out of the annulus/relative to the flow rate into the drillstring may indicate that the drilling fluid has penetrated the formation and is being lost to the formation during the drilling process.

In some MPD procedures, gas injection may be used to control the BHP. In such MPD procedures, gas may be pumped into the annulus between the drillstring and the borehole wall (this annulus may be referred to as the “drilling annulus”) in order to reduce bottomhole-pressure while drilling. Often, the borehole is lined with a pipe that is referred to as a casing string that may be cemented to the borehole wall to, among other things, stabilize the borehole and allow for flow of drilling fluids, production of hydrocarbons from the borehole and/or the like. The drilling annulus may be formed by the annulus lying between the drillstring and the casing string.

Annular gas injection is an MPD process for reducing the BHP in a borehole. In many annular gas injection systems, in addition to lining the borehole with casing, a secondary annulus is created around the drilling annulus by placing an additional pipe around the casing for at least a section of the borehole. This secondary annulus may be connected by one or more orifices at one or more depths to the primary annulus, through which the drilling fluids flow. In this concentric casing type gas injection system, initiating the process of gas injection into the drilling annulus to reduce the BHP can be problematic as, among other things, injection of the gas into the borehole can produce large fluctuations in borehole pressure (the injected gas may create large, oscillating flow of the drilling fluid in the borehole) and achieving a steady-state in the borehole may take hours of unproductive time and/or require pumping large volumes of gas into the borehole. For example, if large gas injectors are used for gas injection, then large flows of drilling fluids may be produced between the gas injection pipe and the drilling annulus. Conversely, if small gas injectors are used, large pressures and gas volumes may be needed to force/inject the gas into the drilling annulus and these large pressures volumes may produce large oscillations in the pressure/flows in the drilling systems.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set

In some embodiments of the present disclosure a method for controlling a bottomhole pressure in a borehole during a drilling procedure is provided in which a borehole is being drilled from a surface location through an earth formation by a drilling system, the method comprising: obtaining measurements from which the bottomhole pressure may be determined during the drilling procedure (e.g. by determining the bottomhole pressure during the drilling procedure from measurements made at or proximal to the surface location) and adjusting operation of the drilling system to control the bottomhole pressure (e.g. by using a controller).

In some embodiments, adjusting the operation of the drilling system to control the bottomhole pressure may comprise injecting gas into a drilling annulus of the drilling system. In some embodiments, adjusting the operation may use feedback measurements comprising at least one of a stand pipe pressure, a compressor pressure and a downhole gas injection rate.

In one embodiment of the present invention a method for controlling a bottomhole pressure in a borehole during a managed pressure drilling procedure—the managed pressure drilling procedure comprising drilling the borehole from a surface location through an earth formation using a drill bit coupled to an end of a drillstring, circulating drilling fluid down the drillstring and back to the surface through an annulus formed between the drillstring and a wall of the borehole, and using a compressor or a combination of a cryogenic pump and an evaporator to inject gas into the returning drilling fluid at a gas injection point at a location in the annulus—the method comprising determining a specified target pressure for the bottomhole pressure or receiving a desired target pressure for the bottomhole pressure; receiving measurements from which the bottomhole pressure can be processed during the drilling procedure; and adjusting a manipulated variable as directed by a feedback controller, which operates to reduce the difference between the target bottomhole pressure and the measured bottomhole pressure, the manipulated variable being any one or any combination of: (1) the pressure of the drilling fluid at the entry of the fluid into the drillstring, (2) the flow rate of the drilling fluid out of the drill string and into the annulus, (3) the pressure of the gas at exit from the compressor or the evaporator, and (4) the injection rate of the gas into the drilling fluid.

In some embodiments, a computer system may be used for performing the methods described above (i.e. controlling a bottomhole pressure in a borehole during a managed pressure drilling procedure in which the borehole is drilled from a surface location through an earth formation by a drill bit coupled to an end of a drillstring, drilling fluid being circulated down the drillstring and returning to surface through an annulus formed between the drillstring and a wall of the borehole, and a compressor or a combination of a cryogenic pump and an evaporator being used to inject gas into the returning drilling fluid at a gas injection point at a location in the annulus). For example, such a computer system may comprise: an interface for receiving a specified target pressure for the bottomhole pressure, and for receiving measurements to determine the bottomhole pressure during the drilling procedure; and one or more processors which may implement a feedback controller and produce, as directed by the feedback controller, a control signal to adjust a manipulated variable, the feedback controller operating to reduce the difference between the target bottomhole pressure and the measured bottomhole pressure, and the manipulated variable being any one or any combination of: (1) the pressure of the drilling fluid at the entry of the fluid into the drillingstring, (2) the pressure of the gas at exit from the compressor or the evaporator, and (3) the injection rate of the gas into the drilling fluid. The computer system may further have a storage medium, operatively connected to the processors, for storing the specified target pressure and/or the measured bottomhole pressure. The processor(s) may be used to determine the measured bottomhole pressure from the received measurements.

Further aspects of the present invention provide: a computer program comprising code which, when run on a computer, causes the computer to perform the method of the first aspect; and a computer readable medium storing a computer program comprising non-transient code which, when run on a computer, causes the computer to perform the method of the first aspect.

In another aspect, a managed pressure drilling system is provided. For example, the managed pressure drilling system may include a borehole drilled from a surface location through an earth formation by a drill bit coupled to an end of a drillstring, the managed pressure drilling system circulating drilling fluid down the drillstring, and the drilling fluid returning to surface through an annulus formed between the drillstring and a wall of the borehole, wherein the managed pressure drilling system further can have a compressor or a combination of a cryogenic pump and an evaporator to inject gas into the returning drilling fluid at a gas injection point at a location in the annulus, and the computer system of the second aspect for controlling the bottomhole pressure in the borehole. The managed pressure drilling system may further have one or more sensors for making measurements to determine of the bottomhole pressure.

Further aspects of embodiments of the present disclosure are now set forth. These, like the embodiments described above are applicable singly or in any combination with each or a combination of the other aspects and/or embodiments as described herein in general terms.

The feedback controller may be a P, PI or a proportional-integral-derivative (PID) controller.

The manipulated variable may be any one or any combination of: the pressure of the drilling fluid at the entry of the fluid into the drillstring, the pressure of the gas at exit from the compressor, and the injection rate of the gas into the drilling fluid.

The method may further comprise making the measurements which determine the bottomhole pressure during the drilling procedure.

The bottomhole pressure may be indirectly measured during the drilling procedure from measurements made at or proximal to the surface location. For example, determining the bottomhole pressure may comprise using feedback measurements from the drilling system.

The measurements may be made essentially continuously during the drilling procedure.

The drilling system may be adjusted in real time to control the bottomhole pressure. In particular, the manipulated variable may be adjusted in real time to reduce the difference between the target bottomhole pressure and the measured bottomhole pressure.

The method may further comprise applying a statistical analysis of the measurements (e.g. indirect measurements made at or proximal to the surface location) to measure the bottomhole pressure during the drilling procedure. In this way, the statistical analysis can determine when the bottomhole pressure has moved outside of a determined pressure window, i.e. when the difference between the target bottomhole pressure and the measured bottomhole pressure has exceeded a threshold. The controller can then adjust the drilling system to control the bottomhole pressure when the bottomhole pressure has moved outside of the determined pressure window. The statistical analysis may comprise at least one of a particle filter, a changepoint analysis, a Monte Carlo process and a Bayesian system.

The method may further comprise applying a surface choke to drilling fluids flowing in the drilling system during the gas injection.

The pressure of the drilling fluid at the entry of the fluid into the drillingstring may be adjusted by adjusting the pump rate of the drilling fluid at the entry of the fluid into the drillingstring. For example, the method may further comprise modulating a pump rate at which drilling fluids are pumped into the drilling system to maintain a gas fraction at the gas injection point to reduce drilling fluid oscillations in the drilling system.

The pressure of the gas at exit from the compressor or the evaporator and/or the injection rate of the gas into the drilling fluid can be adjusted by adjusting the pump rate of the compressor or the cryogenic pump.

The injection rate of the gas into the drilling fluid can be adjusted by adjusting a flow area for the injected gas at the gas injection point. For example, a moving element of a flow valve at the gas injection point can be adjusted e.g. to reduce the injected gas flow area as the flow rate of gas increases.

The drill bit may be a component of a bottom home assembly coupled to the end of the drillstring, and the flow rate of the drilling fluid out of the drill string and into the annulus may then be adjusted by one or more other components (e.g. a pulser) of the bottom home assembly.

The injection rate of the gas into the drilling fluid can be measured (e.g. as a direct measurement of a gas injection rate into the drilling annulus—for example using a flow meter or a differential pressure measurements across an injection orifice), or can be derived from a surface gas flow rate and a rate of change of a gas injection annulus pressure. The injection rate can be corrected using an estimate of a rate of change of a gas mass stored in the annulus, the estimate of the rate of change of the gas mass stored in the annulus being derived from a rate of change of an injection annulus pressure and an equation of state model for the gas.

In the managed pressure drilling procedure, the annulus through which the drilling fluid returns to surface can be an inner annulus, with the compressor or the cryogenic pump flowing the gas through an outer annulus. The gas can then be injected, typically at a sub-surface position, into the inner annulus from the outer annulus. In such an arrangement, a flow valve (e.g. having a moving element, as discussed above) having an adjustable flow area for the injected gas may be provided at the injection point between the outer annulus and the inner annulus. In this way, the flow area can be reduced as the flow rate of gas increases. A second valve may be provided in parallel to the flow valve, the second valve being openable (typically at a high pressure drop between the outer and inner annulus) to allow drilling fluid to be flushed out of the outer annulus and to initiate gas injection. The valve or valves can be retrievable from the surface, enabling valve replacement.

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1 shows a managed pressure drilling system using gas injection.

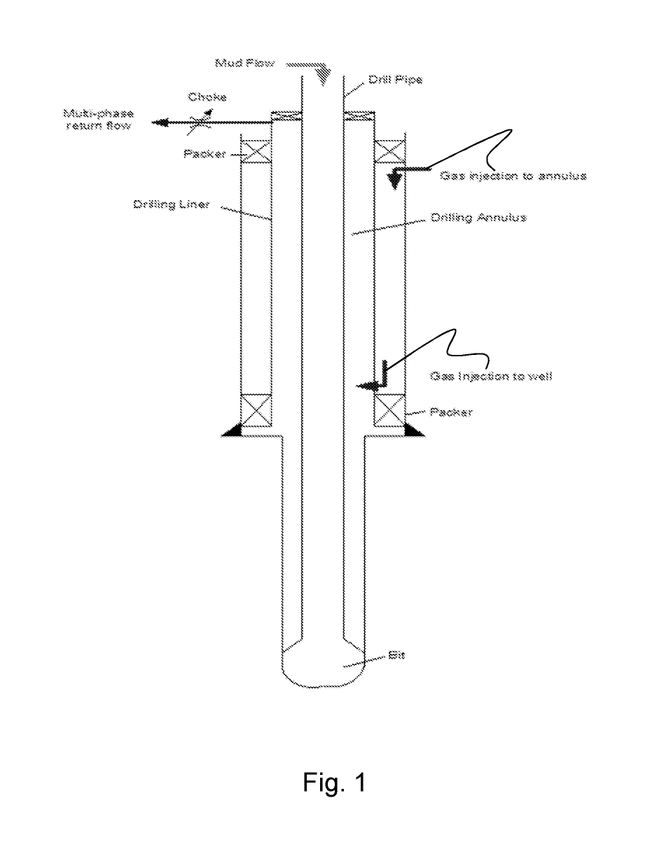

FIG. 2 illustrates a drilling system with a secondary/outer annulus before gas injection.

FIG. 3 illustrates a method for controlling a managed pressure drilling process.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DESCRIPTION

The ensuing description provides some embodiment(s) of the invention, and is not intended to limit the scope, applicability or configuration of the invention or inventions. Various changes may be made in the function and arrangement of elements without departing from the scope of the invention as set forth herein. Some embodiments may be practiced without all the specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Some embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure and may start or end at any step or block. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

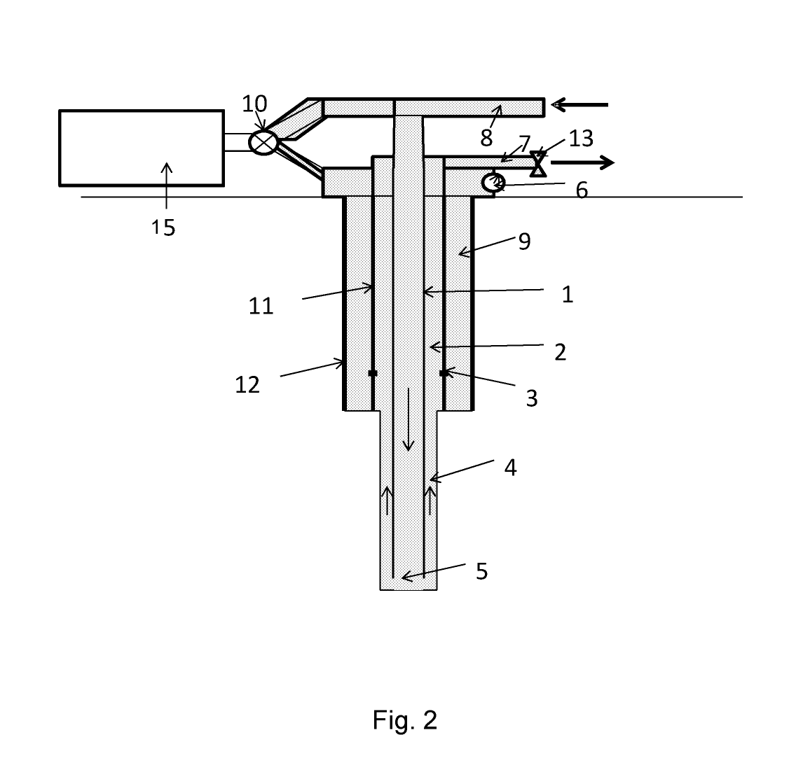

FIG. 2 illustrates the situation in a drilling system with a secondary/outer annulus before gas injection. As depicted, a drillstring 1 is suspended in a borehole 4 (for purposes of this application the terms wellbore, borehole and well may be used interchangeable). In the upper section of the borehole 4 there is an inner annulus 2 (also referred to as a drilling annulus) and a first casing string 11 that is hydraulically connected/in fluid communication with an outer annulus 9 through one or more orifices 3. The outer annulus 9 may itself be cased/lined by a second casing string 12.

The depicted concentric casing injection system is used to inject gas into the borehole 4 that is being drilled through a subterranean formation. The concentric casing injection system comprises the outer annulus 9, which may also be referred to as a gas injection annulus, that surrounds the inner annulus 2, which may also be referred to as a drilling annulus, which drilling annulus is formed between the drillstring 1 disposed in the borehole and the first casing string 11 lining the borehole.

The gas injection annulus may comprise an annulus between the first casing string 11 the second casing string 12, which may be disposed concentrically around the first casing string 11. For example, gas may be pumped into the outer annulus 9 and through one or more gas injection ports 3 into the inner annulus 2. During, gas injection procedures, the concentric casing injection system may become/be unstable because of among other things the combination of the large volume and compliance of the gas in the outer annulus 9 along with the history dependent hydrostatic head of the inner annulus 2.

During conventional gas injection processes, oscillations in BHP of up to 2000 psi (14 MPa) with a period of more than two hours have been recorded. The concentric casing injection system can be damped to prevent such large and/or long-duration oscillations by reducing the size/area of the one or more gas injection ports 3. However, restricting the size of the one or more gas injection ports 3 can make it almost impossible for the gas injection system to displace mud out of the outer annulus 9 and so gas injection into the inner annulus 2 may be prevented and/or restricted; for example it may take injection of large amounts of gas into the outer annulus 9 to displace the mud in the outer annulus 9 through small gas injection ports and this may lead to creating large pressure oscillations in the drilling system, which may require suspension of the drilling procedure.

In MPD, drilling fluid (also referred to herein as drilling mud or mud) may be pumped from a pump(s) (not shown) through pipework 8 into the drillstring 1, down which it passes until it exits at a distal end 5, through a drill bit (not shown) or the like, before returning via the inner annulus 2 and return pipework 7 to fluid tanks for handling/preparing the drilling fluid. Between the pipework 7 and the fluid tanks (not shown) there may be chokes 13 and separators (not shown).

The outer annulus 9 and the pipes feeding the top of the drillstring are connected to gas pumps 15, via a valve manifold 10, which may direct gas either to the drillstring feed, to the outer annulus 9 or optionally to both at once. Measurement of the pressure and other measurements may be made in the outer annulus 9, the inner annulus 2, the drillstring 1 and/or the like. In addition to the described equipment, there may be many other pieces of equipment at the surface, such as blow-out-preventers, a rotating-control-head etc, which are normal with MPD, but which may not be involved in the procedure detailed here, and hence for clarity not shown. Instead of gas pumps 15, the system may have a cryogenic pump and evaporator arrangement for introducing gas into the drilling fluid.

The MPD system may comprise one or more flow ports (not shown) between the outer annulus 9 and the inner annulus 2. The one or more flow ports may allow drilling mud to flow between the inner annulus 2 and the outer annulus 9. For example, during the drilling process mud may be flowing in the inner annulus 2 and may flow through the one or more flow ports into the outer annulus 9. The one or more gas injection ports 3 may be smaller than the one or more flow ports.

Injection of gas into the drilling mud in the borehole serves to lower the hydrostatic head of the drilling mud and, in turn, lower the BHP. As such, by controlling the flow of gas into the drilling mud, the BHP can be controlled during the drilling procedure. In theory, the use of gas to control BHP is relatively simple. However, in practice, the borehole may be several thousand feet or meters long, and as such the gas is being injected into a column of drilling fluid that is itself of the orders of thousands of feet/meters. In MPD operations, the pumping of gas at rates sufficient for injection of a required volume of gas into the borehole to control the BHP may cause the drilling fluid to oscillate in the borehole producing large fluctuations in well pressure. When these oscillations are occurring, the drilling procedure has to be halted until the drilling fluid resumes a steady-state in the borehole, which may take hours of unproductive time. In the worst case scenario, the injection of gas may cause u-tubing, where sections/slugs of gas and drilling fluid may undergo wild oscillations within the borehole.

In the present invention, the BHP in a gas injection MPD procedure (often referred to as multiphase MPD) is controlled using feedback from the state of the MPD procedure. For example, a determination of the BHP is made from measurements made at or near to the surface, which measurements are of the order of thousands of feet away from the bottom of the borehole being drilled. By controlling/managing the BHP on an essentially continuous basis during the MPD procedure the need for injection of large volumes of gas in short periods of time may be prevented/reduced and the large perturbations to/oscillations of the drilling fluid in the borehole may be prevented/reduced. The window for the BHP may be calculated based on the presence of an amount of gas in the drilling fluid, in this manner gas may be continuously pumped into the borehole during the MPD procedure avoiding the need to initiate gas injection. Additionally or alternatively, feedback from the MPD procedure may be used to control the gas injection and, as a result, control the BHP.

As noted previously, the drilled borehole may be thousands of feet/meters in length and, during the MPD procedure, drilling fluid is continuously pumped down the drillstring and back up through the drilling annulus. The BHP may be measured by one or more pressure sensors on the bottomhole assembly (“BHA”) or on the drillstring. Measurements from such sensors may be communicated to the surface using wired drillpipe and/or mud pulse telemetry. Complications with mud pulse telemetry are the time it takes for the data to be transmitted to the surface, preventing/reducing effectiveness of active control, and the fact that mud pulse telemetry is not possible when the drilling fluid in the borehole is u-tubing.

Advantageously, it has been found that stand pipe pressure, the pressure of the drilling fluid at the surface, the compressor pressure and/or the like can be used to derive/estimate the BHP. Surprisingly, given the length of the borehole in a drilling procedure, which length may be many thousands of feet/meters, it has been found that feedback control based on measurements from the surface may be used to control surface operations, such as the choke, gas injection rate, drilling fluid composition, drilling fluid pump rate and/or the like and manage the BHP. Feedback control of the MPD process can impose constraints on MPD operations to prevent adverse effects, such as u-tubing, large drilling fluid oscillations and/or the like. This allows real time control of the MPD and use of gas injection and MPD operations that are designed to produce a desired BHP without the adverse effects.

Even though the bottom of the borehole and the surface from which the borehole is being drilled may be separated by thousands of meters/feet, by continuously monitoring changes in measurements made at the surface—such as drilling fluid flow rates, stand pipe pressure, choke pressure/level and/or the like—the bottomhole pressure can be monitored and changes to the drilling procedure—such as drilling fluid weight, pump rate, choke pressure/level, gas injection parameters and/or the like—can be made to control the bottomhole pressure and keep it in a desired pressure window.

The BHP may be essentially continuously determined using pressure sensors on the BHA/drillstring, stand pipe pressure measurements and/or the like. When the BHP is found to be outside of a desired pressure zone, one or more of the gas injection rate, the liquid injection rate or the surface choke pressure may be adjusted to bring the pressure back to the desired target. The condition of the well may be calculated from one or more of the measured bottomhole pressure, the measured choke pressure, the measured gas injection pressure or the actual gas injection rate into the drilling annulus that is measured directly or derived from other measurements. In this way, gas flow rates, liquid flow rates and choke pressures can be set such that the gas flow will reduce the BHP without causing large oscillation in the drilling fluid.

For example, a processor or the like may be used to control one or more of the parameters. Sensors such as pressure and/or flow rate sensors may be used to monitor the flow of gas out of a compressor and/or into the drilling annulus. The actual flow of the gas out of the compressor and/or into the drilling annulus and/or a measured BHP after gas injection has commenced may be used to evaluate/update this controller and as a result calculate necessary changes to the injection flow rate. A proportional controller (“P controller”), a proportional-integral controller (“PI controller”) or a proportional-integral-derivative controller (“PID controller”) may be used to control the gas injection. A P, PI or PID controller is a generic control loop feedback mechanism in which the P, PI or PID controller calculates an “error” value as the difference between a measured process variable and a desired set-point and the controller attempts to minimize the error by adjusting the process control inputs.

In the absence of a suitable direct BHP measurement, the feedback measurement for control of BHP may be an indirect BHP measurement based on e.g. the stand pipe pressure.

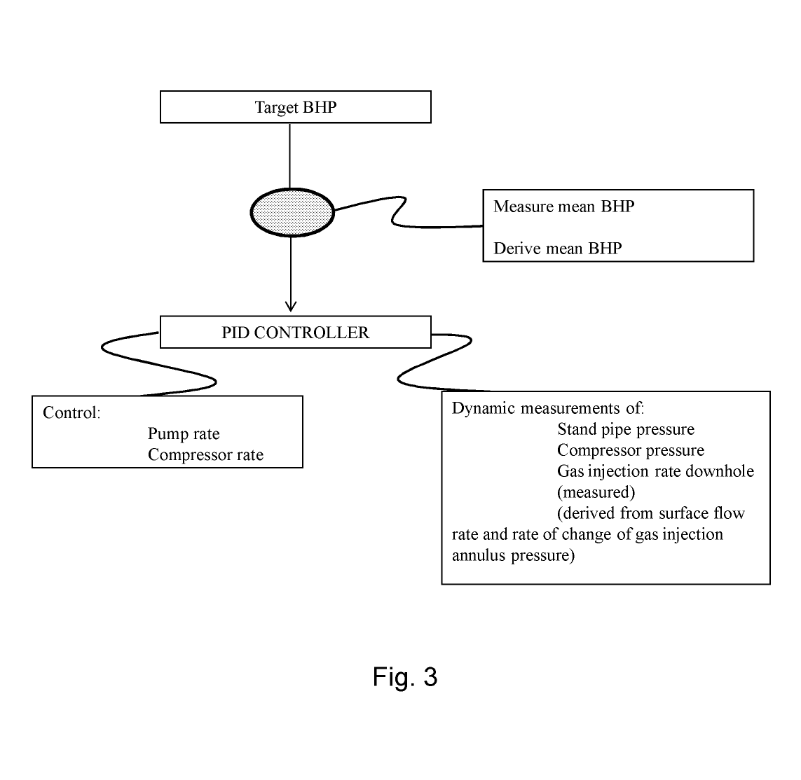

FIG. 3 illustrates a method for controlling an MPD process. As depicted, a target BHP is determined. This determination may be derived from experiments, experience with similar MPD processes, experience with drilling in similar/nearby locations, modelling and/or the like. The target BHP may be determined from pore pressure, drilling fluid characteristics and/or the like. A mean BHP may be measured. A mean BHP may be derived from measurements made during the MPD process. During the MPD process, dynamic measurements may be made of the stand pipe pressure, compressor pressure and/or the downhole gas injection rate. This latter parameter may be directly measured or derived for example from the surface flow rate and an estimate of the change in gas mass stored in the injection annulus. The target BHP and the mean BHP as well as the stand pipe pressure, compressor pressure and/or the downhole gas injection rate may be fed into a feedback controller, such as a PID controller, which may process these values and control the pump rate of the injected gas and or the compressor rate so as to keep the BHP at the target value.

The feedback measurements of BHP during gas injection and/or gas flow of the injected gas during gas injection are used to control operation of pressure control devices. For example, the feedback measurements may be used to control the surface choke. In other words, the derived gas injection rate may be used as feedback for controlling the MPD process. In this way, an integrated system is provided for BHP management where the surface choke is operated in combination with gas injection to control the BHP without producing large oscillation in the drilling fluid. For example, contrary to expectations, it may be desirable to at least partially apply the surface choke during gas injection in order to lessen oscillations produced by the gas injection.

The pump rate of the surface pumps pumping the drilling fluid into the drillstring during the MPD may be modulated based upon the BHP measurements and/or the feedback measurements. Modulating the pump rate to maintain a gas fraction at the gas injection point has been found to reduce drilling fluid oscillations.

A processor or the like may be used to control the chokes, pumps and/or the like to control the flow of gas into the drilling system. The processor may also be used to process mud properties, such as density or the like, that will provide the desired hydrostatic head given a defined vertical separation of the one or more gas injection ports 3 and the one or more flow ports. Where the one or more gas injection ports 3 and/or the one or more flow ports comprise nozzles or valves, the processor may control the operation/characteristics (i.e. size, orientation and/or the like) of the gas injection and/or the flow ports. Use of a processor may provide for intelligent gas injection into the drilling system.

The feedback from measurements of the BHP, the flow rate of the injected gas and/or the like is used to provide for controlling the MPD procedure. Passive control of the MPD procedure may comprise, controlling the maximum mud/drilling fluid flow rate. Maximum mud flow rate limiting may provide long term damping of the system oscillations, but in the short term such control may not improve system stability. Max mud rate control may, however, mitigate/prevent U-tubing and/or enable stand pipe pressure interpretation of BHP. Moreover, max mud rate control may provide for maintaining measurement while drilling (“MWD”) telemetry during the MPD process.

Methods for mud/drilling fluid flow rate control may include:
Using a nozzle in the BHA to provide a flow restriction to reduce flow changes and prevent U-tubing.
Using a flow limiting valve, similar to a Water Flow Regulator (WFR), to provide that when the flow rate rises past a set threshold, a bobbin or the like moves and closes/reduces flow area for the drilling fluid and increasing pressure drop.
Smart use of a MWD turbine to close/reduce flow area when flow rate increases and/or using control system based on pressure drop, either active or passive, to control the flow rate of the drilling fluid. Additionally, the MWD turbine may be used to evaluate flow rate either from the position of the blades in the turbine and pressure drop or from pressure drop across another known orifice or other flow meter.

An MWD tool typically comprises a turbine, a pulser as well as the option to have multiple pressure sensors inside/outside the drillstring and/or BHA. Thus, in one example, an MWD turbine may be used as a flow meter, the pulser can be used as a flow control valve and the pressure transducers can be used as sensors for the system. The MPD procedure may be controlled with an appropriate controller and feedback from the measured BHP and/or flow properties of the gas. The MWD tool may be used as a downhole MPD controller. Merely by way of example, for a concentric casing gas injection MPD system, the MWD tool may modulate the drilling fluid flow based on the interpretation of the BHP to yield a desired gas injection rate. This control can be combined with the surface pumps being set to a constant surface pressure rather than a fixed flow rate.

In another example by using a flow limiting valve (e.g. of WFR type or the like) for the gas flow, the gas injection rate may be controlled and, in turn, the BHP may be controlled. In parallel with such a gas flow rate control by the flow limiting valve, a larger valve may be opened at a specific high pressure drop (merely by way of example, a pressure drop of more than 200 psi (1.4 MPa) differential) to allow the higher flow rate of fluid out of the injection annulus. Thus, in relation to the drilling system of FIG. 2, such valves may be installed to control the flow of gas through the gas injection ports 3. A first valve, similar to a WFR, can have a moving element to reduce the flow area as the flow rate of gas through the ports increases, and a second valve, mounted in parallel to the first valve, opens when a large pressure drop occurs between the outer injection annulus 9 and the inner drilling annulus 2 to allow mud to be pumped out of the outer annulus and initiate gas injection. The valves can be installed into a completion. Moreover, they can be fitted to a gas lift mandrel and can thus be retrieved without pulling the completion from the well, e.g. to replace when worn or to fit a different size valve.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the scope of the present disclosure, and that they may make various changes, substitutions, alterations and/or combinations of the embodiments/aspects described herein without departing from the scope of the present disclosure. For example, the use of language and/or separating the description into embodiments, which is generally provided for ease of description/understanding, should not be considered limiting and features described in one embodiment/aspect may of course be combined with/integrated into other described embodiments/aspects described herein.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

1. A method for controlling a bottomhole pressure in a borehole (4) during a managed pressure drilling procedure in which the borehole is drilled from a surface location through an earth formation by a drill bit coupled to an end (5) of a drillstring (1), drilling fluid being circulated down the drillstring and returning to surface through an annulus (2) formed between the drillstring and a wall of the borehole, and a compressor (15) or a combination of a cryogenic pump and an evaporator being used to inject gas into the returning drilling fluid at a gas injection point (3) at a location in the annulus, wherein the method comprises:
receiving a specified target pressure for the bottomhole pressure;
receiving measurements which determine the bottomhole pressure during the drilling procedure; and
adjusting a manipulated variable as directed by a feedback controller which operates to reduce the difference between the target bottomhole pressure and the measured bottomhole pressure, the manipulated variable being any one or any combination of: (1) the pressure of the drilling fluid at the entry of the fluid into the drillingstring, (2) the flow rate of the drilling fluid out of the drill string and into the annulus, (3) the pressure of the gas at exit from the compressor or the evaporator, and (4) the injection rate of the gas into the drilling fluid.

2. A method according to claim 1, wherein the feedback controller is a P, PI or PID controller.

3. A method according to claim 1, wherein the bottomhole pressure is indirectly measured during the drilling procedure from measurements made at or proximal to the surface location.

4. A method according to claim 1, wherein bottomhole pressure is measured essentially continuously during the drilling procedure.

5. A method according to claim 1, wherein the manipulated variable is adjusted in real time to reduce the difference between the target bottomhole pressure and the measured bottomhole pressure.

6. A method according to claim 1, wherein a surface choke (13) is applied to the drilling fluids returning to surface through the annulus.

7. A method according to claim 1, wherein the pressure of the drilling fluid at the entry of the fluid into the drillingstring is adjusted by adjusting the pump rate of the drilling fluid at the entry of the fluid into the drillingstring.

8. A method according to claim 1, wherein the pressure of the gas at exit from the compressor or the evaporator is adjusted by adjusting the pump rate of the compressor or the cryogenic pump.

9. A method according to claim 1, wherein the injection rate of the gas into the drilling fluid is adjusted by adjusting the pump rate of the compressor or the cryogenic pump.

10. A method according to claim 1, wherein the injection rate of the gas into the drilling fluid is adjusted by adjusting a flow area for the injected gas at the gas injection point.

11. A method according to claim 1, wherein the drill bit is a component of a bottom home assembly coupled to the end of the drillstring, and the flow rate of the drilling fluid out of the drill string and into the annulus is adjusted by one or more other components of the bottom home assembly.

12. A computer system for performing the method of claim 1.

13. A computer program comprising code which, when run on a computer, causes the computer to perform the method of claim 1.

14. A computer readable medium storing a computer program comprising code which, when run on a computer, causes the computer to perform the method of claim 1.

15. A managed pressure drilling system having a borehole (4) drilled from a surface location through an earth formation by a drill bit coupled to an end (5) of a drillstring (1), the managed pressure drilling system circulating drilling fluid down the drillstring, the drilling fluid returning to surface through an annulus (2) formed between the drillstring and a wall of the borehole, wherein the managed pressure drilling system further has a compressor (15) or a combination of a cryogenic pump and an evaporator to inject gas into the returning drilling fluid at a gas injection point (3) at a location in the annulus, and the computer system of claim 12 for controlling the bottomhole pressure in the borehole.

16. A managed pressure drilling system according to claim 15, wherein the annulus through which the drilling fluid returns to surface is an inner annulus, and the managed pressure drilling system further has an outer annulus (9) through which the compressor or the cryogenic pump flow the gas; and wherein the gas is injected into the inner annulus from the outer annulus through a flow valve at the injection point, the flow valve having an adjustable flow area for the injected gas.
